(19) United States
(12) Patent Application Publication
(10) Pub. No.: US 2017/0034650 A1
(43) Pub. Date: Feb. 2, 2017

(54) DELAYED ADAPTIVE TILE DOWNLOAD

(71) Applicant: QUALCOMM Incorporated, San Diego, CA (US)

(72) Inventors: Jeemil Shah, San Diego, CA (US); Ashok Bhatia, San Diego, CA (US); Neethu Joseph, San Diego, CA (US); Wei Chen, San Diego, CA (US)

(21) Appl. No.: 14/811,588

(22) Filed: Jul. 28, 2015

(51) Int. Cl. H04W 4/02; H04W 24/10

(52) U.S. Cl. CPC H04W 4/02; H04W 24/10

(57) ABSTRACT

Example methods, apparatuses, or articles of manufacture are disclosed herein that may be utilized, in whole or in part, to facilitate or support one or more operations or techniques for delayed adaptive tile download, such as for use in or with a mobile communication device, for example.

### BACKGROUND

1. Field

The present disclosure relates generally to position or location estimations of mobile communication devices and, more particularly, to delayed adaptive tile download for use in or with mobile communication devices.

2. Information

Mobile communication devices, such as, for example, cellular telephones, portable navigation units, laptop computers, personal digital assistants, or the like are becoming more common every day. Certain mobile communication devices, such as, for example, location-aware cellular telephones, smart telephones, or the like may assist users in estimating their geographic locations by providing positioning assistance parameters obtained or gathered from various systems. For example, in an outdoor environment, certain mobile communication devices may obtain an estimate of their geographic location or so-called “position fix” by acquiring wireless signals from a satellite positioning system (SPS), such as the global positioning system (GPS) or other like Global Navigation Satellite Systems (GNSS), cellular base station, etc. via a cellular telephone or other wireless communications network. Acquired wireless signals may, for example, be processed by or at a mobile communication device, and its location may be estimated using known techniques, such as Advanced Forward Link Trilateration (AFLT), base station identification, cell tower triangulation, or the like.

In an indoor environment, mobile communication devices may be unable to reliably receive or acquire satellite or like wireless signals to facilitate or support one or more position estimation techniques. For example, signals from an SPS or other wireless transmitters may be attenuated or otherwise affected in some manner (e.g., insufficient, weak, fragmentary, etc.), which may at least partially preclude their use for position estimations. At times, a mobile communication device may obtain a position fix by measuring ranges to three or more terrestrial wireless access points positioned at known locations. Ranges may be measured, for example, by obtaining a Media Access Control identifier (MAC ID) address from wireless signals received from suitable access points and measuring one or more characteristics of received signals, such as signal strength, round trip delay, or the like. In some instances, a position of a mobile communication device may also be estimated via radio heat map signature matching. For example, current or live characteristics of wireless signals received at a mobile communication device may be compared with expected or previously measured signal characteristics stored as heat map values in a database. By finding a signature in a database that more closely matches characteristics exhibited by signals currently received at a mobile communication device, a location associated with a matching signature may be used as an estimated location of the device.

At times, a position fix of a mobile communication device may, for example, be obtained in connection with one or more positioning tiles. For example, a number of wireless transmitters, indoor or otherwise, may be grouped into a geographically-bounded area (e.g., 1.0 km by 1.0 km square, etc.) to comprise and/or be defined via a so-called “positioning tile” or simply “tile.” A tile may include positioning assistance parameters, such as locations, identities, etc. for a set of known wireless transmitters, for example, representative of and/or corresponding to a particular geographic area. As such, a mobile communication device may retrieve (e.g., access, download via a server, etc.) and/or use one or more tiles to estimate its location within an area using one or more known techniques, such as, for example, techniques mentioned above (e.g., triangulation, radio heat map signature matching, range measurement, etc.).

In some instances, however, such as if a mobile communication device travels via a route covered by multiple tiles of positioning assistance parameters (e.g., a co-located user is commuting from San Diego to San Jose, etc.), for example, it may need to download or use numerous tiles to maintain adequate positioning performance. At times, more frequent tile downloads may significantly tax available resources, such as bandwidth in wireless communication links, for example. This may also affect memory of a mobile communication device, especially if only a smaller portion of downloaded parameters (e.g., locations, identities, etc. of wireless transmitters proximate to a traveled route, etc.) is needed or useful for positioning. More frequent tile downloads may also increase power consumption of certain mobile communication devices, such as mobile devices with limited power resources (e.g., battery-operated, etc.), for example, thus, affecting operating lifetime or overall utility of such devices.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating features associated with an implementation of an example operating environment.

FIG. 2 is a flow diagram illustrating an implementation of an example process that may be performed to facilitate or support delayed adaptive tile download.

FIG. 3 is a schematic diagram of an implementation of an example geographic region.

FIG. 4 is a flow diagram illustrating another implementation of an example process that may be performed to facilitate or support delayed adaptive tile download.

FIG. 5 is a schematic diagram illustrating an implementation of an example computing environment associated with a mobile device.

FIG. 6 is a schematic diagram illustrating an implementation of an example computing environment associated with a server.

### SUMMARY

Example implementations relate to techniques for delayed adaptive tile download. In one implementation, a method may comprise transmitting, via a mobile device, one or more first messages to a server, the one or more first messages comprising measurements obtained at the mobile device; receiving one or more second messages from the server, the one or more second messages comprising an estimated location of the mobile device computed based, at least in part, on the measurements in the one or more first messages; and selectively requesting a tile of positioning assistance parameters for an area including the estimated location based, at least in part, on a history of visits of the mobile device to the area, the tile being requested for use in obtaining one or more subsequent position fixes at the mobile device based, at least in part, on one or more subsequent measurements within the area

In another implementation, an apparatus may comprise means for transmitting, via a mobile device, one or more first messages to a server, the one or more first messages comprising measurements obtained at the mobile device; means for receiving one or more second messages from the server, the one or more second messages comprising an estimated location of the mobile device computed based, at least in part, on the measurements in the one or more first messages; and means for selectively requesting a tile of positioning assistance parameters for an area including the estimated location based, at least in part, on a history of visits of the mobile device to the area, the tile being requested for use in obtaining one or more subsequent position fixes at the mobile device based, at least in part, on one or more subsequent measurements within the area.

In yet another implementation, an apparatus may comprise a mobile device comprising a wireless transceiver to communicate with an electronic communications network; and one or more processors coupled to a memory to transmit one or more first messages to a server, the one or more first messages comprising measurements obtained at the mobile device; receive one or more second messages from the server, the one or more second messages comprising an estimated location of the mobile device computed based, at least in part, on the measurements in the one or more first messages; and selectively request a tile of positioning assistance parameters for an area including the estimated location based, at least in part, on a history of visits of the mobile device to the area, the tile being requested for use in obtaining one or more subsequent position fixes at the mobile device based, at least in part, on one or more subsequent measurements within the area.

In yet another implementation, a method may comprise collecting measurements of wireless transmitters in an area; obtaining a position fix based, at least in part, on the measurements of the wireless transmitters; and in response to determining that the position fix being in a cluster of previous position fixes, accessing a tile of positioning assistance parameters covering the area and the position fix for use in obtaining subsequent position fixes based, at least in part, on subsequent measurements of at least one of the wireless transmitters in the area. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations and/or techniques for delayed adaptive tile download for use in or with mobile communication devices. As used herein, “mobile device,” “mobile communication device,” “location-aware mobile device,” or like terms may be used interchangeably and may refer to any kind of special purpose computing platform or apparatus that may from time to time have a position or location that changes. In some instances, a mobile communication device may, for example, be capable of communicating with other devices, mobile or otherwise, through wireless transmission or receipt of information according to one or more communication protocols. As a way of illustration, special purpose mobile communication devices, which may herein be called simply mobile devices, may include, for example, cellular telephones, smart telephones, personal digital assistants (PDAs), laptop computers, personal entertainment systems, tablet personal computers (PC), personal audio or video devices, personal navigation devices, radio heat map generation tools, or the like. It should be appreciated, however, that these are merely examples of mobile devices that may be used, at least in part, to implement one or more operations and/or techniques for delayed adaptive tile download, and that claimed subject matter is not limited in this regard. It should also be noted that the terms “position” and “location” may be used interchangeably herein.

As was indicated, at times, a position fix of a mobile device may, for example, be obtained based, at least in part, on positioning assistance parameters that may be selectively provided to the mobile device, such as by a navigation system, location server, or the like. In some instances, positioning assistance parameters may comprise, for example, one or more parameters descriptive of attributes of wireless transmitters (e.g., Wi-Fi access points, cellular base stations, etc.) positioned at known locations. These attributes may include, for example, MAC addresses, cellular identification numbers (Cell IDs), transmission power levels, characteristics of wireless signals indicative of received signal strength (e.g., RSSI, etc.), round-trip delay times (e.g., RTT, etc.), etc., just to provide a few examples. With the knowledge of one or more attributes of wireless transmitters, a mobile device may then estimate its location, such as using one or more appropriate techniques, as was also indicated. One technique for obtaining positioning assistance parameters for a mobile device may include, for example, accessing the parameters via a remote server (e.g., location server, positioning assistance server, etc.), such as through a selection of a Uniform Resource Locator (URL). In addition, at times, positioning assistance parameters may comprise, for example, electronic digital map-related parameters (e.g., for additional context, etc.), radio heat map values (e.g., to assist in localization, etc.), or the like, such as for an area of interest, indoor or otherwise. Of course, these are merely examples of positioning assistance parameters, and claimed subject matter is not so limited.

As was also indicated, in some instances, a mobile device may obtain positioning assistance parameters defined in and/or characterized via one or more so-called “positioning tiles.” As used herein, the terms “positioning tile” or “tile” may be used interchangeably and may refer to one or more parameters descriptive of attributes of wireless transmitters grouped with respect to one or more predefined geographically-bounded areas (e.g., 1.0 km by 1.0 km squares, etc.). Such attributes may include, for example, locations, transmission power, unique identifiers (e.g., Wi-Fi MAC address, Cell ID, etc.), etc. of wireless transmitters, such as located within and/or proximate to a particular geographically-bounded area. In operative use, a mobile device may, for example, perform a “scan” (e.g., an active scan, passive scan, etc.) to acquire signals transmitted by proximate or “visible” wireless transmitters and/or detect particular parameters encoded in the acquired signals (e.g., unique identifiers, etc.). As a way of illustration, an active scan may, for example, be performed via transmitting one or more requests, such as in the form of one or more unicast packets and receiving one or more responses, and a passive scan may, for example, be performed by “listening” for or discovering wireless signals broadcasted by proximate wireless transmitters.

In some instances, one or more detected parameters may, for example, be transmitted to a suitable server, such as a location server, positioning assistance server, etc. in an appropriate message. In response, a server may, for example, transmit a message to a mobile device so as to indicate a set of tiles that may be used, at least in part, for positioning in an area of interest, and, in some instances, may recommend that the mobile device select one specific tile of the set that may be particularly effective and/or useful given unique identifiers obtained via a scan. A mobile device may then download one or more tiles from a server, for example, and may use associated parameters for positioning using one or more appropriate techniques (e.g., triangulation, proximity, etc.), as was indicated. At times, a mobile device may transmit one or more detected parameters to a server along with a request to compute a position fix, such as without requesting and/or downloading a tile, for example. In response, a server may, for example, transmit one or more messages to a mobile device including its estimated location. In some instances, a response message from a server may also reveal one or more available tiles that may be used, at least in part, for obtaining future position fixes within an area proximate to an estimated location, for example. If desired or otherwise appropriate, a mobile device may, for example, select to download one or more revealed tiles and may locally store these tiles for use in one or more future positioning operations. It should be noted that “wireless transmitters” and “transmitters” may be used interchangeably herein, and may be capable of transmitting and/or receiving wireless signals, depending on an implementation.

As alluded to previously, at times, continual communications between a mobile device and a server, such as for position-related responses, for example, may tax available network bandwidth, require uninterrupted wireless coverage or connectivity, increase packet overhead, affect cellular plan data usage, or the like. Continually downloading tiles of positioning assistance parameters may also tax associated computational resources, lead to increased processing times, affect power consumption of a mobile device, or the like. For example, in some instances, such as if a user of a co-located mobile device regularly commutes along a route covered by multiple tiles of positioning assistance parameters, to free local memory for subsequent tile downloads, if applicable or useful, the mobile device may repeatedly download and then delete multiple tile sets covering the route. In addition, typical Wi-Fi tile downloads (e.g., General Packet Radio Service Tunneling Protocol (GTP)-Wi-Fi, etc.) may not differentiate, for example, between a moving and a stationary mobile device, meaning that the same volume of parameters may be downloaded to the device irrespective of a co-located user's mobility and/or usage patterns. Again, at times, this may significantly increase cellular plan data usage, power consumption of a mobile device, etc., as was indicated. Accordingly, it may be desirable to develop one or more methods, systems, or apparatuses that may enable or otherwise improve mobile device location and/or navigation services, such as in connection with one or more positioning tiling techniques, for example.

Thus, as will be described in greater detail below, in an implementation, to obtain one or more position fixes within an area of interest, a mobile device may, for example, initially rely on communications with and/or position-related response messages from a server, such as prior to downloading one or more tiles of positioning assistance parameters. In some instances, however, such as if certain one or more conditions are satisfied, for example, to reduce reliance on a server, conserve cellular plan data usage, prolong battery life, etc., a mobile device may, for example, select to download one or more tiles that are expected to contain positioning assistance parameters likely to be useful in one or more future attempted position fixes. For example, parameters likely to be useful in future attempted position fixes may include those covering an area that a user may be more likely to frequent, such as home, office, route to work or store, or the like. As will be seen, at times, tile selection and/or download may, for example, be conditioned, at least in part, on a history of visits of a mobile device to an area of interest. Depending on an implementation, a history of visits may include, for example, a number of estimated locations of a mobile device clustered within an area, a number of visits by a mobile device to an area, a number of tile requests for an area, time spent by a mobile device within an area, etc, or any combination thereof. Claimed subject matter is not so limited, of course. For example, in some instances, a type of a wireless network, cellular carrier, particularities of a service contract, mobile device's processing capability and/or memory resources, etc. may be part of a history of visits and may be used, at least in part, or otherwise considered. As was indicated, a mobile device may locally store one or more downloaded tiles of positioning assistance parameters, such as, for example, in a cache, main memory, etc. and may obtain subsequent position fixes autonomously using any suitable positioning technique, such as triangulation, trilateration, radio heat map signature matching, proximity, or the like.

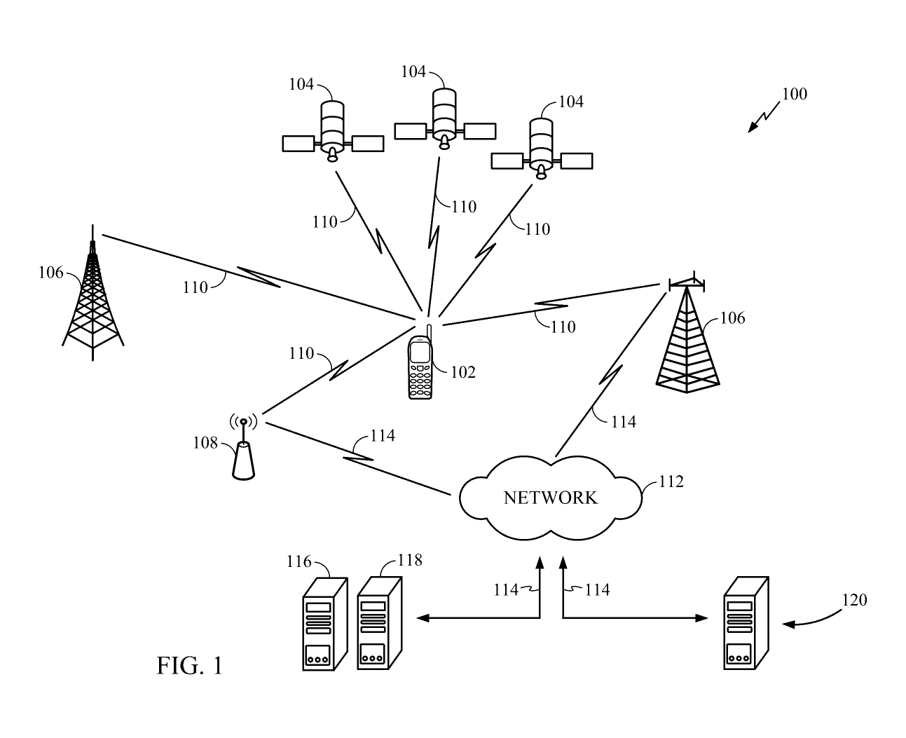

FIG. 1 is a schematic diagram illustrating features associated with an implementation of an example operating environment 100 capable of facilitating or supporting one or more processes or operations for delayed adaptive tile download, such as for use in or with a mobile device 102, for example. It should be appreciated that operating environment 100 is described herein as a non-limiting example that may be implemented, in whole or in part, in the context of various communications networks or combination of networks, such as public networks (e.g., the Internet, the World Wide Web), private networks (e.g., intranets), wireless local area networks (WLAN, etc.), or the like. It should also be noted that claimed subject matter is not limited to indoor implementations. For example, at times, one or more operations or techniques described herein may be performed, at least in part, in an indoor-like environment, which may include partially or substantially enclosed areas, such as urban canyons, town squares, amphitheaters, parking garages, rooftop gardens, patios, or the like. At times, one or more operations or techniques described herein may be performed, at least in part, in an outdoor environment.

As illustrated, operating environment 100 may comprise, for example, one or more satellites 104, base stations 106, wireless transmitters 108, etc. capable of communicating with mobile device 102 via wireless communication links 110 in accordance with one or more communication protocols. Satellites 104 may be associated with one or more satellite positioning systems (SPS), such as, for example, the United States Global Positioning System (GPS), the Russian GLONASS system, the European Galileo system, as well as any system that may utilize satellites from a combination of satellite systems, or any satellite system developed in the future. Base stations 106, wireless transmitters 108, etc. may be of the same or similar type, for example, or may represent different types of devices, such as access points, radio beacons, cellular base stations, femtocells, or the like, depending on an implementation. At times, one or more wireless transmitters, such as wireless transmitters 108, for example, may be capable of transmitting as well as receiving wireless signals. Although not shown, in some instances, operating environment 100 may, for example, include a relatively larger number of wireless transmitters 108 associated with an indoor or like area of interest.

In some instances, one or more base stations 106, wireless transmitters 108, etc. may, for example, be operatively coupled to a network 112 that may comprise one or more wired or wireless communications or computing networks capable of providing suitable information, such as via one or more wireless communication links 114, 110, etc. As will be seen, information may include, for example, positioning assistance parameters, such as locations, identities, etc. of one or more base stations 106, wireless transmitters 108, etc., a radio heat map, positioning tile, recent position fix obtained via an SPS, or the like. As a way of illustration, positioning assistance parameters may, for example, be provided in the form of a list, digital map, look-up table, mathematical formula, suitable model, algorithm, heat map metadata, etc., which may depend, at least in part, on an application, network, environment, or the like. In an implementation, network 112 may be capable of facilitating or supporting communications between suitable computing platforms or devices, such as, for example, mobile device 102, one or more base stations 106, wireless transmitters 108, as well as one or more servers associated with operating environment 100. In some instances, servers may include, for example, a location server 116, positioning assistance server 118, as well as one or more other servers, indicated generally at 120 (e.g., navigation, information, map, etc. server, etc.), capable of facilitating or supporting one or more operations or processes associated with operating environment 100.

Location server 116 may provide a coarse location of mobile device 102 with operating environment 100. In addition, at times, location server 116 may, for example, provide a location context identifier (LCI) for a particular area of interest. An LCI may comprise or be associated with a locally defined area, such as a particular floor of a building or other indoor or like area of interest that is not mapped according to a global coordinate system (e.g., mapped according to a local coordinate system, etc.), just to illustrate one possible implementation. Thus, in some instances, mobile device 102 may communicate a request to location server 116 to provide one or more LCIs covering an area of interest or adjacent areas, if applicable. Here, a request may reference or otherwise include, for example, a coarse location of mobile device 102, as was indicated, such that location server 116 may associate the coarse location of mobile device 102 with an area covered by one or more LCIs, and then communicate relevant LCIs to mobile device 102. In some instances, mobile device 102 may utilize one or more received LCIs, in whole or in part, in subsequent messages with a suitable server, such as server 120, for example, to obtain navigation, map, or other information relevant to an area identified by one or more LCIs (e.g., a digital map, routeability graph, etc.).

Positioning assistance server 118 may, for example, provide positioning assistance parameters, such as identities, locations, etc. of relevant wireless transmitters, a radio heat map covering an area of one or more LCIs, though claimed subject matter is not so limited. For example, in some instances, positioning assistance parameters may comprise a positioning tile that may be used, at least in part, to compute a position fix of mobile device 102 in an area of interest.

Server 120 may comprise a map server, for example, that may provide an electronic digital map (e.g., for additional context, etc.) as well as other positioning assistance parameters or like information for a particular area of interest. An electronic digital map may comprise, for example, a floor plan, street layout, etc. of an area or portion thereof and may indicate locations of one or more wireless transmitters 108, base stations 106, etc. relative to mobile device 102, one or more areas within operating environment 100, or the like.

Even though a certain number of computing platforms or devices are illustrated herein, any number of suitable computing platforms or devices may be implemented to facilitate or otherwise support one or more techniques or processes associated with operating environment 100. For example, at times, network 112 may be coupled to one or more wired or wireless communications networks (e.g., Wi-Fi, etc.) so as to enhance a coverage area for communications with mobile device 102, one or more base stations 106, wireless transmitters 108, servers (116, 118, 120), or the like. In some instances, network 112 may facilitate or support femtocell-based operative regions of coverage, for example. Again, these are merely example implementations, and claimed subject matter is not limited in this regard.

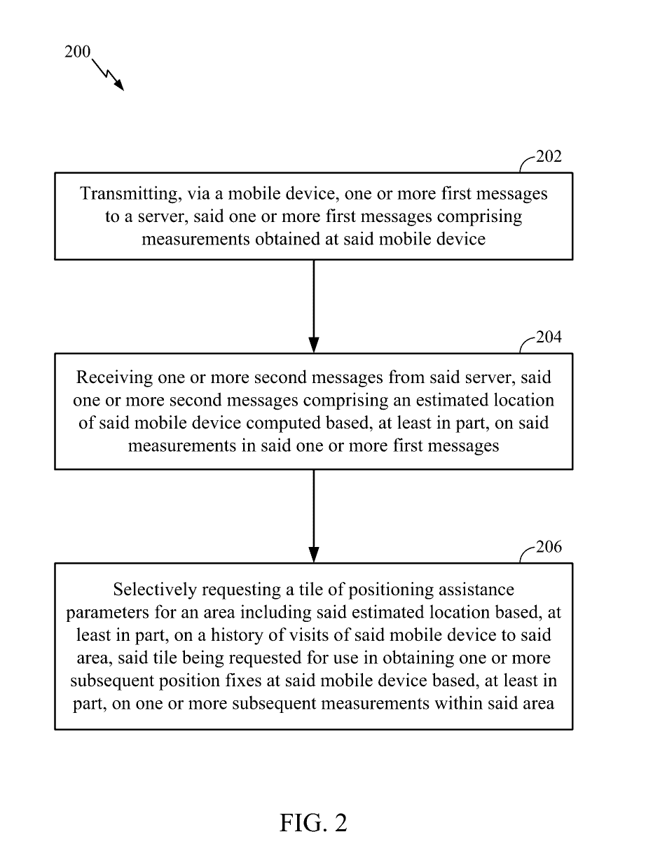

With this in mind, attention is now drawn to FIG. 2, which is a flow diagram illustrating an implementation of an example process 200 that may be performed, in whole or in part, to facilitate or support one or more operations or techniques for delayed adaptive tile download. As was indicated, at times, process 200 may be implemented, at least in part, via a location-aware mobile device, such as, for example, mobile device 102 of FIG. 1, though claimed subject matter is not so limited. For example, in some instances, one or more operations of process 200 may be implemented, at least in part, via a server device, such as one or more servers 116, 118, and/or 120 of FIG. 1. It should be noted that information acquired or produced, such as, for example, input signals, output signals, operations, results, etc. associated with example process 200 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

Example process 200 may, for example, begin at operation 202 with transmitting, via a mobile device, one or more first messages to a server, the one or more first messages comprising measurements obtained at the mobile device. As was indicated, measurements obtained at a mobile device, such as in connection with a scan (e.g., active, passive, etc.) may comprise, for example, locations, identities, characteristics, etc. of one or more proximate or “visible” wireless transmitters (e.g., Wi-Fi access points, cellular base stations, etc.), such as MAC addresses, Cell IDs, transmission power levels, etc. In some instances, measurements obtained at a mobile device may comprise, for example, measurements of transmissions of one or more wireless transmitters indicative of timing and/or signaling characteristics of detected or observed wireless signals, such as received signal strength-related measurements (e.g., RSSI, etc.), round-trip delay times-related measurements (e.g., RTT, etc.), or the like. Claimed subject matter is not limited to these particular measurements, of course. Any suitable measurements capable of facilitating or supporting obtaining a position fix of a mobile device via any appropriate techniques may be used herein, in whole or in part, or otherwise considered. Obtained measurements may, for example, be transmitted to a server using any suitable messaging and/or communication technique and/or in any suitable form or structure. For example, obtained measurements may be transmitted via one or more wireless communications links (e.g., links 110, 114 of FIG. 1, etc.) in the form of table, matrix, or the like. In some instances, obtained measurements may, for example, be transmitted in the form of a scan list (e.g., an IEEE std. 802.11 scan list, etc.) that may comprise a set of wireless transmitters (e.g., Wi-Fi access points, etc.) observed by a mobile device within a particular area of interest over a time period (e.g., one hour, twenty-four hours, few days, etc.), just to illustrate another possible implementation.

With regard to operation 204, one or more second messages may, for example, be received from the server, the one or more second messages comprising an estimated location of the mobile device computed based, at least in part, on the measurements in the one or more first messages. As was also indicated, an estimated location of a mobile device may be computed via any suitable positioning technique, such as, for example, AFLT, A-GPS, base station identification, radio heat map signature matching, cell tower triangulation, via last or recent position fix obtained via an SPS and/or dead reckoning, or the like. In some instances, an estimated location may, for example, be computed using proximity of a mobile device to one or more applicable reference points, such as by knowing which wireless transmitter the mobile device is using and/or communicating with at a given time. These or like positioning techniques are known and need not be described here in greater detail. Claimed subject matter is not limited to a particular positioning technique, of course.

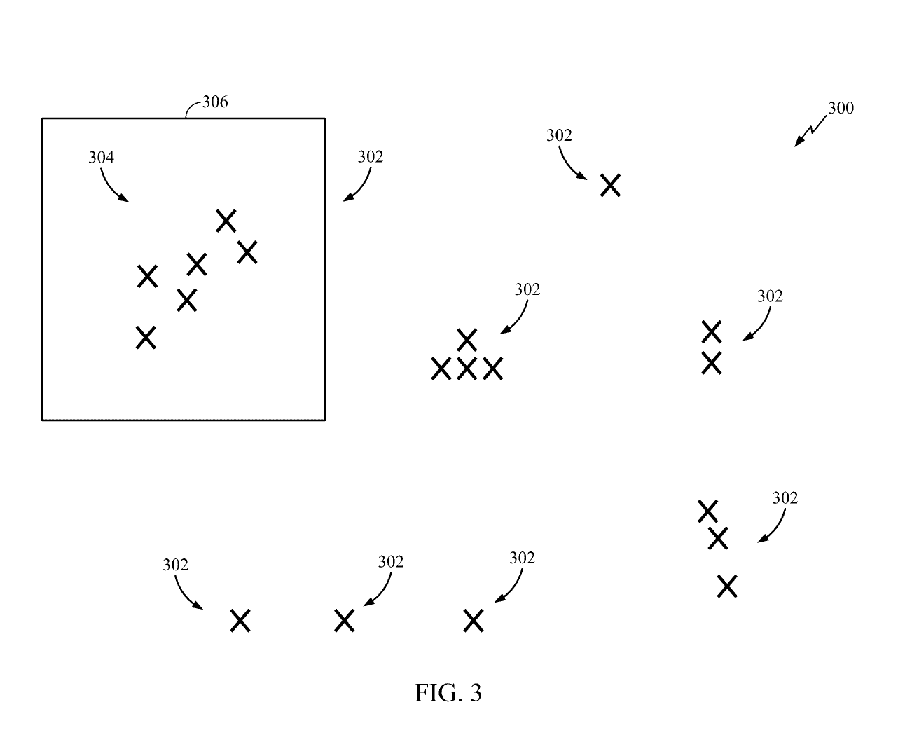

Thus, having computed an estimated location of a mobile device, a server may, for example, transmit one or more response (e.g., second, etc.) messages with the estimated location to the mobile device. For example, as illustrated via a schematic diagram of an example geographic region 300 of FIG. 3, estimated locations of a mobile device, such as received via one or more second messages may include those indicated generally at 302. As such, here, a mobile device may, for example, rely, at least initially, on communications with and/or position-related response messages from a server, such as prior to downloading one or more tiles of positioning assistance parameters, as discussed below.

Referring back to example process 200 of FIG. 2, at operation 206, a tile of positioning assistance parameters for an area including the estimated location may, for example, be selectively requested based, at least in part, on a history of visits of the mobile device to the area. In some instances, the tile of positioning assistance parameters may, for example, be requested for use in obtaining one or more subsequent position fixes at the mobile device based, at least in part, on one or more subsequent measurements within the area. In at least one implementation, a history of visits of a mobile device to an area of interest may comprise, for example, a number of estimated locations of the mobile device clustered within the area. Thus, at times, a mobile device may select to download a tile, such as revealed by a server in response to processing measurements from a scan list, for example, if a current estimated location of the mobile device is in a cluster with a number of other, previously estimated locations of the mobile device.

More specifically, one or more estimated locations (e.g., estimated locations 302 of FIG. 3, etc.) may, for example, be saved in a suitable memory (e.g., a cache, main memory, etc.) of a mobile device, server, or any combination thereof, such as with reference to an applicable scan list, geographic region, mobile device, wireless carrier, types of measurements, or the like. With each positioning request and/or location estimate, consecutive or absolute, a server, mobile device, etc. may, for example, determine if a current estimated location is within some threshold distance from an immediately preceding estimated location. If so, a server, mobile device, etc. may, for example, mark or designate such an event or occurrence as a “matched” position fix or “matched” estimated location. Each position fix marked or designated as “matched” may, for example be counted in some manner (e.g., consecutively, etc.), such as via a suitable counter associated with a server, mobile device, etc. If such a counter reaches or exceeds some threshold number, a server, mobile device, etc. may, for example, infer that a resulting cluster of estimated locations lies within a geographic area for which positioning assistance parameters are likely to be useful in one or more future attempted position fixes (e.g., in an area a user is more likely to frequent, etc.). As such, a mobile device may, for example, access a server and/or download a tile of positioning assistance parameters covering such an area, as was indicated.

A threshold distance between estimated locations as well as a threshold number of “matched” position fixes may be determined, at least in part, experimentally and may be set, pre-defined, and/or configured (e.g., by a user, service provider, etc.), for example, or otherwise dynamically defined in some manner depending on a particular environment, application, geographic area, tile, mobile device, or the like. By way of example but not limitation, in one particular simulation or experiment, it appeared that a threshold distance in a range between 50.0 and 100.0 meters may prove beneficial for delayed adaptive tile download. In addition, it appeared that a threshold number of “matched” position fixes of 5 (five) may also prove beneficial. Of course, details relating to a threshold distance and/or a threshold number of “matched” position fixes are intended as merely examples to which claimed subject matter is not limited.

As a way of illustration, using an example implementation of geographic region 300 of FIG. 3, in operative use, a mobile device may, for example, delay downloading a tile of positioning assistance parameters and may initially rely on communications with and/or position-related response messages from a server, such as to obtain one or more estimated locations 302. In some instances, however, such as if certain one or more conditions are satisfied, for example, to reduce reliance on a server, etc., a mobile device may, for example, select to download one or more tiles that are expected to contain positioning assistance parameters likely to be useful in one or more future attempted position fixes. Namely, it may be determined that for each estimated location, such as within a cluster 304, for example, a number of subsequent location estimates were within some threshold distance from previous location estimates, such as to comprise a number of “matched” position fixes discussed above. Depending on an implementation, a number of subsequent location estimates and/or a number of previous location estimates may comprise, for example, a number of consecutive position fixes within a threshold distance, an absolute number of position fixes within a threshold distance, or any combination thereof. In addition, it may also be determined, such as via a suitable counter, for example, that a number of “matched” position fixes within cluster 304 reached some threshold number (e.g., 5 “matched” position fixes, etc.). As such, here, a mobile device may, for example, request and/or download a tile of positioning assistance parameters, indicated at 306, which may cover an area of a current estimated location that is within a cluster of previous estimated locations (e.g., cluster 304, etc.). As was indicated, a mobile device may, for example, locally store tile 306 for use in obtaining one or more subsequent position fixes based, at least in part, on one or more subsequent measurements within an area covered by tile 306 using any suitable positioning technique, such as triangulation, trilateration, radio heat map signature matching, proximity, or the like.

Although not shown, in some instances, a tile of positioning assistance parameters, such as tile 306, for example, may comprise a hierarchical or nesting multi-level tiling structure, meaning that a plurality of smaller-sized tiles may be arranged in some manner to fit within a larger-sized tile. For example, at times, tile 306 may be subdivided into a number of sub-tiles that may or may not be appended at the edges and/or may or may not be overlapping. To illustrate, tile 306 may comprise a first level tile comprising a plurality of second level tiles, a second level tile may comprise a plurality of third level tiles, and so forth. In a like fashion, tile 306 may be part of a larger-sized tile, for example. At times, tile 306 may comprise, for example, a lower-resolution tile, such as having a smaller number of positioning assistance parameters capable of facilitating or supporting obtaining a coarser or less precise position fix (e.g., within ten, twenty, etc. feet, meters, etc. from an actual location, etc.). In some instances, tile 306 may comprise, for example, a higher-resolution tile, such as having a larger number of positioning assistance parameters capable of facilitating or supporting obtaining a finer or more precise position fix (e.g., within a few feet, meters, etc. from an actual location, etc.). Of course, claimed subject matter is not limited to a particular tiling structure and/or hierarchy. Also, even though a rectangular tile is shown, any suitable tile shape, tessellating or otherwise, may be used, in whole or in part.

Thus, depending on an implementation and/or history of visits, different versions, sizes, etc. of a tile of positioning assistance parameters may, for example, be offered and/or provided to a mobile device. For example, a lower-resolution version of a tile may be offered and/or provided if a user of a co-located mobile device travels rapidly through an area covered by such a tile (e.g., driving on a highway, etc.), if time spent by a user in such an area is below some time threshold (e.g., 10, 15, etc. minutes), if a user visited such an area only a certain number of times (e.g., less than 5, 10, etc. times within a week, month, etc.), or the like. Providing or offering a lower-resolution tile may, for example, improve power consumption, utilization of memory and/or processing resources of a mobile device, or the like on an as-needed basis. In turn, a finer-resolution version of a tile may, for example, be offered and/or provided if a history of visits to an area indicates that a user of a co-located mobile device visits the area a sufficient number of times (e.g., 20, 30, etc. times per week, etc.), if time spent by a user in such an area meets or exceeds some time threshold (e.g., 30, 60, etc. minutes) indicating that a user may not be driving through, if a number of tile requests for such an area meets or exceeds some threshold (e.g., 5, 10, etc, requests within an hour, etc.) indicating area's popularity, or the like. Of course, these are merely examples relating to tiles of positioning assistance parameters that may be used, at least in part, to facilitate one or more operations or processes discussed herein, and claimed subject matter is not so limited. For example, in some instances, a type of a wireless network, cellular carrier, particularities of a service contract, mobile device's processing capability and/or memory resources, etc. may be part of a history of visits and may be used, at least in part, or otherwise considered in determining whether to download or delay downloading a tile of positioning assistance parameters, a number of tiles to download, a type of a tile to offer and/or download, or the like.

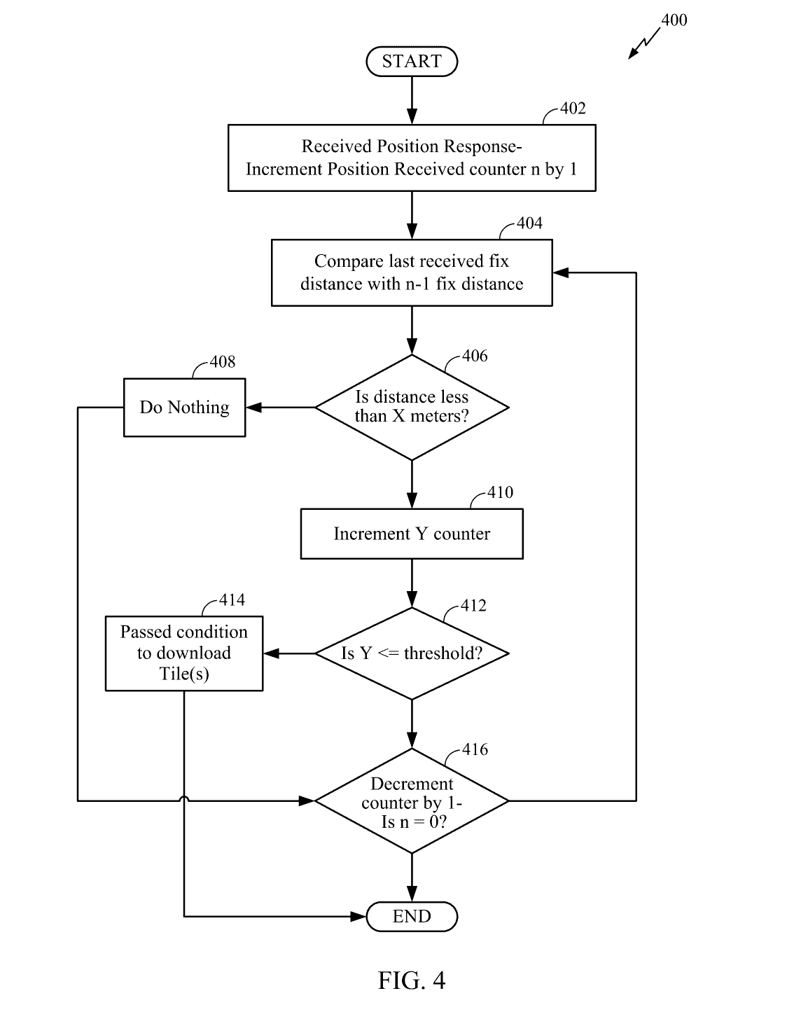

FIG. 4 is a flow diagram illustrating another implementation of an example process, referenced at 400, that may be performed, in whole or in part, to facilitate or support one or more operations or techniques for delayed adaptive tile download. As was indicated, at times, process 400 may be implemented, at least in part, via a location-aware mobile device, such as, for example, mobile device 102 of FIG. 1, though claimed subject matter is not so limited. For example, in some instances, one or more operations of process 400 may be implemented, at least in part, via a server device, such as one or more servers 116, 118, and/or 120 of FIG. 1. Likewise, it should be noted that information acquired or produced, such as, for example, input signals, output signals, operations, results, etc. associated with example process 400 may be represented via one or more digital signals. It should also be appreciated that even though one or more operations are illustrated or described concurrently or with respect to a certain sequence, other sequences or concurrent operations may be employed. In addition, although the description below references particular aspects or features illustrated in certain other figures, one or more operations may be performed with other aspects or features.

As illustrated, example process 400, after starting, may proceed to operation 402 at which a counter counting a number of position fixes n (e.g., computed via measurements obtained at a mobile device, etc.) may be incremented by 1 (one) every time a position fix is computed (e.g., on a server, etc.) and/or a response is received (e.g., on a mobile device, etc.). Obtained and/or received position fixes may, for example, be stored in a suitable memory, as previously indicated. At operation 404, it may be determined, for example, whether there is a “matched” position fix, such as by comparing distances between a current position fix and an immediately preceding position fix, as discussed above. With regard to operation 406, it may be determined whether a current position fix is within a threshold distance X meters (e.g., 50, 100, etc. meters) from an immediately preceding position fix. If no, process 400 may, for example, ignore such a position fix, as referenced at 408, and may proceed to operation 416 discussed below. If it is determined, however, that a current position fix is within a threshold distance X meters from an immediately preceding position fix, at operation 410, a counter Y counting a number of “matched” position fixes may be incremented in some manner, such as by 1 (one), for example.

With regard to operation 412, it may be determined whether a counter Y counting a number of “matched” position fixes reached or exceeded some threshold number. As was indicated, such a threshold number may be user, service provider, etc. configurable. If a threshold number of “matched” position fixes is reached or exceeded, such that a current position fix is in a cluster of previous position fixes, consecutive or absolute (e.g., one or more conditions are satisfied, etc.), for example, a mobile device may request and/or download a tile available from and/or offered by a server, as illustrated at 414, and process 400 may be terminated. However, if a threshold number of “matched” position fixes is not reached or exceeded, at operation 416, a counter Y may be decremented in some manner, such as by 1. Here, it may also be determined if a number of position fixes n=0, for example. If so, process 400 may terminate. If a number of position fixes n>0, however, process 400 may loop back to operation 404, such as for another determination of a “matched” position fix, such as with respect to another area of interest, for example, if applicable. Having downloaded a suitable tile of positioning assistance parameters (e.g., higher-resolution, lower-resolution, nesting, etc.), a mobile device may, for example, be capable of obtaining one or more subsequent position fixes using one or more applicable techniques (e.g., triangulation, radio heat map signature matching, proximity, etc.).

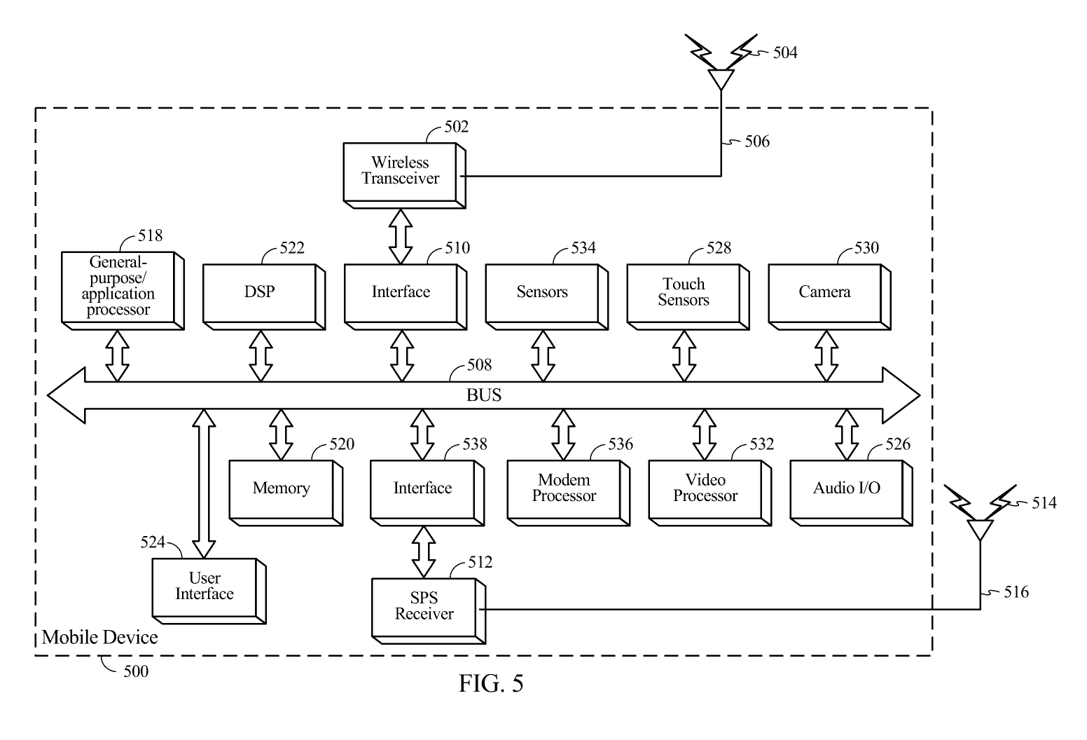

FIG. 5 is a schematic diagram of an implementation of an example computing environment associated with a mobile device that may be used, at least in part, to facilitate or support one or more operations or techniques for delayed adaptive tile download. An example computing environment may comprise, for example, a mobile device 500 that may include one or more features or aspects of mobile device 102 of FIG. 1, though claimed subject matter is not so limited. For example, in some instances, mobile device 500 may comprise a wireless transceiver 502 capable of transmitting or receiving wireless signals, referenced generally at 504, such as via an antenna 506 over a suitable wireless communications network. Wireless transceiver 502 may, for example, be coupled or connected to a bus 508 via a wireless transceiver bus interface 510. Depending on an implementation, at times, wireless transceiver bus interface 510 may, for example, be at least partially integrated with wireless transceiver 502. Some implementations may include multiple wireless transceivers 502 or antennas 506 so as to enable transmitting or receiving signals according to a corresponding multiple wireless communication standards such as Wireless Fidelity (WiFi), Code Division Multiple Access (CDMA), Wideband-CDMA (W-CDMA), Long Term Evolution (LTE), Bluetooth®, just to name a few examples.

In an implementation, mobile device 500 may, for example, comprise an SPS receiver 512 capable of receiving or acquiring one or more SPS signals 514, such as via an SPS antenna 516. SPS receiver 512 may process, in whole or in part, one or more acquired SPS signals 514 for estimating a location of mobile device 500. In some instances, one or more general-purpose application processors 518, memory 520, digital signal processor(s) (DSP) 522, or like specialized devices or processors not shown may be utilized to process acquired SPS signals 514, in whole or in part, calculate a location of mobile device 500, such as in conjunction with SPS receiver 512, or the like. Storage of SPS or other signals for implementing one or more positioning operations, such as in connection with delayed adaptive tile download, for example, may be performed, at least in part, in memory 520, suitable registers or buffers (not shown). Although not shown, it should be appreciated that in at least one implementation one or more processors 518, memory 520, DSPs 522, or like specialized devices or processors may comprise one or more processing modules capable of transmitting one or more first messages to a server, the one or more first messages comprising measurements obtained at mobile device 500; receiving one or more second messages from the server, the one or more second messages comprising an estimated location of mobile device 500 computed based, at least in part, on the measurements in the one or more first messages; and selectively requesting a tile of positioning assistance parameters for an area including the estimated location based, at least in part, on a history of visits of mobile device 500 to the area, the tile being requested for use in obtaining one or more subsequent position fixes at mobile device 500 based, at least in part, on one or more subsequent measurements within the area. It should also be noted that all or part of one or more image processing modules may be implemented using or otherwise including hardware, firmware, software, or any combination thereof.

As illustrated, DSP 522 may be coupled or connected to processor 518 and memory 520 via bus 508. Although not shown, in some instances, bus 508 may comprise one or more bus interfaces that may be integrated with one or more applicable components of mobile device 500, such as DSP 522, processor 518, memory 520, or the like. In various embodiments, one or more operations or functions described herein may be performed in response to execution of one or more machine-readable instructions stored in memory 520, such as on a computer-readable storage medium, such as RAM, ROM, FLASH, disc drive, etc., just to name a few examples. Instructions may, for example, be executable via processor 518, one or more specialized processors not shown, DSP 522, or the like. Memory 520 may comprise a non-transitory processor-readable memory, computer-readable memory, etc. that may store software code (e.g., programming code, instructions, etc.) that may be executable by processor 518, DSP 522, or the like to perform operations or functions described herein.

Mobile device 500 may comprise a user interface 524, which may include any one of several devices such as, for example, a speaker, microphone, display device, vibration device, keyboard, touch screen, etc., just to name a few examples. In at least one implementation, user interface 524 may enable a user to interact with one or more applications hosted on mobile device 500. For example, one or more devices of user interface 524 may store analog or digital signals on memory 520 to be further processed by DSP 522, processor 518, etc. in response to input or action from a user. Similarly, one or more applications hosted on mobile device 500 may store analog or digital signals in memory 520 to present an output signal to a user. In some implementations, mobile device 500 may optionally include a dedicated audio input/output (I/O) device 526 comprising, for example, a dedicated speaker, microphone, digital to analog circuitry, analog to digital circuitry, amplifiers, gain control, or the like. It should be understood, however, that this is merely an example of how audio I/O device 526 may be implemented, and that claimed subject matter is not limited in this respect. As seen, mobile device 500 may comprise one or more touch sensors 528 responsive to touching or like pressure applied on a keyboard, touch screen, or the like.

In an implementation, mobile device 500 may comprise, for example, a camera 530, dedicated or otherwise, such as for capturing still or moving imagery. Camera 530 may comprise, for example, a camera sensor or like imaging device (e.g., charge coupled device, complementary metal oxide semiconductor (CMOS)-type imager, etc.), lens, analog to digital circuitry, frame buffers, etc., just to name a few examples. In some instances, additional processing, conditioning, encoding, or compression of signals representing one or more captured images may, for example, be performed, at least in part, at processor 518, DSP 522, or the like. Optionally or alternatively, a video processor 532, dedicated or otherwise, may perform conditioning, encoding, compression, or manipulation of signals representing one or more captured images. Additionally, video processor 532 may, for example, decode or decompress one or more stored images for presentation on a display (not shown) of mobile device 500.

Mobile device 500 may comprise one or more sensors 534 coupled or connected to bus 508, such as, for example, one or more inertial sensors, ambient environment sensors, or the like. Inertial sensors of sensors 534 may comprise, for example, one or more accelerometers (e.g., collectively responding to acceleration of mobile device 500 in one, two, or three dimensions, etc.), gyroscopes or magnetometers (e.g., to support one or more compass applications, etc.), etc., just to illustrate a few examples. Ambient environment sensors of mobile device 500 may comprise, for example, one or more temperature sensors, barometric pressure sensors, ambient light detectors, camera sensors, microphones, etc., just to name few examples. Sensors 534 may generate analog or digital signals that may be stored in memory 520 and may be processed by DSP 522, processor 518, etc., such as in support of one or more applications directed to positioning or navigation operations, communications, gaming or the like.

In a particular implementation, mobile device 500 may comprise a modem processor 536, dedicated or otherwise, capable of performing baseband processing of signals received or downconverted via wireless transceiver 502, SPS receiver 512, or the like. Similarly, modem processor 536 may perform baseband processing of signals to be upconverted for transmission via wireless transceiver 502, for example. In alternative implementations, instead of having a dedicated modem processor, baseband processing may be performed, at least in part, by processor 518, DSP 522, or the like. In addition, in some instances, an interface 538, although illustrated as a separate component, may be integrated, in whole or in part, with one or more applicable components of mobile device 500, such as bus 508 or SPS receiver 512, for example. Optionally or alternatively, SPS receiver 512 may be coupled or connected to bus 508 directly. It should be understood, however, that these are merely examples of components or structures that may perform baseband processing, and that claimed subject matter is not limited in this regard.

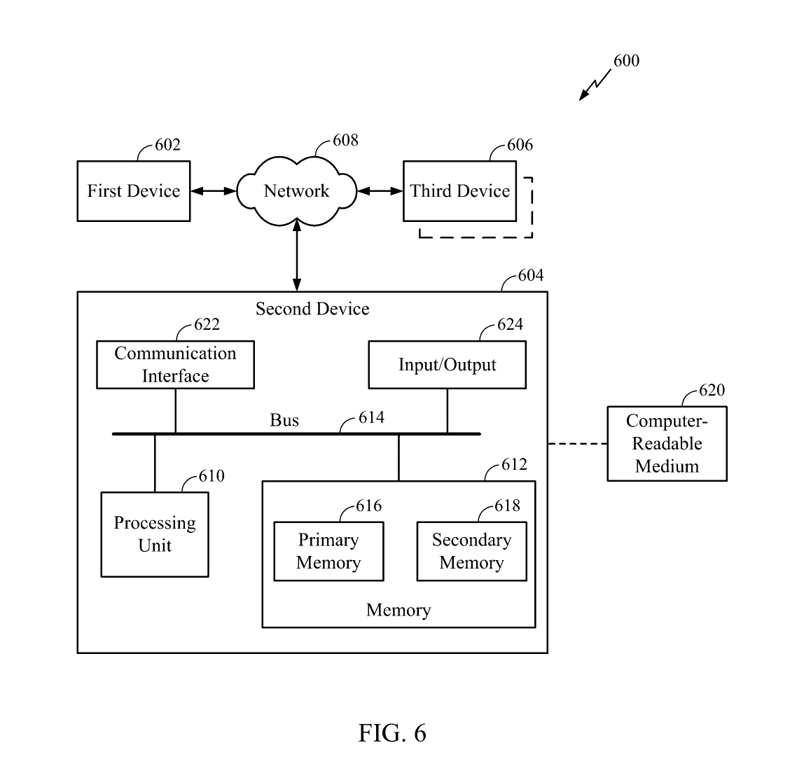

FIG. 6 is a schematic diagram illustrating an implementation of an example computing environment or system 600 that may be associated with or include one or more servers or other devices capable of partially or substantially implementing or supporting one or more operations or processes for delayed adaptive tile download, such as discussed above in connection with FIGS. 1-5, for example. Computing environment 600 may include, for example, a first device 602, a second device 604, a third device 606, etc., which may be operatively coupled together via a communications network 608. In some instances, first device 602 may comprise a server capable of providing positioning assistance parameters, such as discussed above. First device 602 may also comprise a server capable of providing a location based, at least in part, on one or more first messages comprising measurements obtained at a mobile device, as was also indicated. First device 602 may also comprise a server capable of providing positioning assistance data relevant to a location of an LCI specified in a request from a mobile device. Second device 604 or third device 606 may comprise, for example, mobile devices, just to illustrate one possible implementation. In addition, communications network 608 may comprise one or more wireless transmitters, such as access points, femtocells, or the like. Of course, claimed subject matter is not limited in scope in these respects.

First device 602, second device 604, or third device 606 may be representative of any device, appliance, platform, or machine that may be capable of exchanging information over communications network 608. By way of example but not limitation, any of first device 602, second device 604, or third device 606 may include: one or more computing devices or platforms, such as, for example, a desktop computer, a laptop computer, a workstation, a server device, or the like; one or more personal computing or communication devices or appliances, such as, for example, a personal digital assistant, mobile communication device, or the like; a computing system or associated service provider capability, such as, for example, a database or information storage service provider/system, a network service provider/system, an Internet or intranet service provider/system, a portal or search engine service provider/system, a wireless communication service provider/system; or any combination thereof. Any of first, second, or third devices 602, 604, and 606, respectively, may comprise one or more of a mobile device, wireless transmitter or receiver, server, etc. in accordance with example implementations described herein.

In an implementation, communications network 608 may be representative of one or more communication links, processes, or resources capable of supporting an exchange of information between at least two of first device 602, second device 604, or third device 606. By way of example but not limitation, communications network 608 may include wireless or wired communication links, telephone or telecommunications systems, information buses or channels, optical fibers, terrestrial or space vehicle resources, local area networks, wide area networks, intranets, the Internet, routers or switches, and the like, or any combination thereof. As illustrated, for example, via a dashed lined box partially obscured by third device 606, there may be additional like devices operatively coupled to communications network 608. It is also recognized that all or part of various devices or networks shown in computing environment 600, or processes or methods, as described herein, may be implemented using or otherwise including hardware, firmware, software, or any combination thereof.

By way of example but not limitation, second device 604 may include at least one processing unit 610 that may be operatively coupled to a memory 612 via a bus 614. Processing unit 610 may be representative of one or more circuits capable of performing at least a portion of a suitable computing procedure or process. For example, processing unit 610 may include one or more processors, controllers, microprocessors, microcontrollers, application specific integrated circuits, digital signal processors, programmable logic devices, field programmable gate arrays, or the like, or any combination thereof. Although not shown, second device 604 may include a location-tracking unit that may obtain a position fix, coarse or otherwise, of a suitable mobile device, for example, based, at least in part, on one or more received or acquired wireless signals, such as from an SPS, one or more Wi-Fi access points, etc., in connection with obtained measurements, tile of positioning assistance parameters, electronic digital map, etc. In some implementations, a location-tracking unit may be at least partially integrated with a suitable processing unit, such as processing unit 610, for example, though claimed subject matter is not so limited. In certain server-based or server-supported implementations, processing unit 610 may, for example, comprise means for transmitting one or more first messages, the one or more first messages comprising measurements obtained at a mobile device, such as to facilitate or support operation 202 of FIG. 2, at least in part. In some instances, processing unit 610 may, for example, comprise means for receiving one or more second messages, the one or more second messages comprising an estimated location of a mobile device computed based, at least in part, on the measurements in the one or more first messages, such as to facilitate or support operation 204 of FIG. 2, for example. Depending on an implementation, processing unit 610 may also comprise, for example, means for selectively requesting a tile of positioning assistance parameters for an area including the estimated location based, at least in part, on a history of visits of the mobile device to the area, the tile being requested for use in obtaining one or more subsequent position fixes at the mobile device based, at least in part, on one or more subsequent measurements within the area, such as to facilitate or support operation 206 of FIG. 2, at least in part.

According to an implementation, processing unit 610 may also comprise, for example, means for collecting measurements of wireless transmitters in an area; means for obtaining a position fix based, at least in part, on the measurements of the wireless transmitters; and means for accessing, in response to determining that the position fix being in a cluster of previous position fixes, a tile of positioning assistance parameters covering the area and the position fix for use in obtaining subsequent position fixes based, at least in part, on subsequent measurements of at least one of the wireless transmitters in the area, such as to facilitate or support one or more operations 202-206 of FIG. 2 and/or operations 402-416 of FIG. 4, at least in part.

Memory 612 may be representative of any information storage mechanism or appliance. Memory 612 may include, for example, a primary memory 616 and a secondary memory 618. Primary memory 616 may include, for example, a random access memory, read only memory, etc. While illustrated in this example as being separate from processing unit 610, it should be understood that all or part of primary memory 616 may be provided within or otherwise co-located/coupled with processing unit 610. Secondary memory 618 may include, for example, same or similar type of memory as primary memory or one or more information storage devices or systems, such as, for example, a disk drive, an optical disc drive, a tape drive, a solid state memory drive, etc. In certain implementations, secondary memory 618 may be operatively receptive of, or otherwise configurable to couple to, a computer-readable medium 620. Computer-readable medium 620 may include, for example, any non-transitory storage medium that may carry or make accessible information, code, or instructions for one or more of devices in computing environment 600. Computer-readable medium 620 may also be referred to as a storage medium.

Second device 604 may include, for example, a communication interface 622 that may provide for or otherwise support an operative coupling of second device 604 to at least communications network 608. By way of example but not limitation, communication interface 622 may include a network interface device or card, a modem, a router, a switch, a transceiver, and the like. Second device 604 may also include, for example, an input/output device 624. Input/output device 624 may be representative of one or more devices or features that may be configurable to accept or otherwise introduce human or machine inputs, or one or more devices or features that may be capable of delivering or otherwise providing for human or machine outputs. By way of example but not limitation, input/output device 624 may include an operatively configured display, speaker, keyboard, mouse, trackball, touch screen, information port, or the like.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (DSPs), digital signal processing devices (“DSPDs”), programmable logic devices (“PLDs”), field programmable gate arrays (“FPGAs”), processors, controllers, micro-controllers, microprocessors, electronic devices, other devices units de-signed to perform the functions described herein, or combinations thereof.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, messages, parameters, frames, packets, content and/or the like. It should be understood, however, that all of these and/or similar terms are to be associated with appropriate physical quantities or manifestations, and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. Likewise, operation of a memory device to store bits, values, elements, symbols, characters, terms, numbers, numerals, measurements, messages, parameters, frames, packets, content and/or the like may comprise a physical transformation. With particular types of memory devices, such a physical transformation may comprise a physical transformation of an article to a different state or thing. For example, but without limitation, for some types of memory devices, a change in state may involve an accumulation and/or storage of charge or a re-lease of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) net-work, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (“CDMA”) cellular communication protocol, for example, and the femtocell may provide the mobile device access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

1. A method for performing a positioning operation, comprising:
transmitting, via a mobile device, one or more first messages to a server, said one or more first messages comprising measurements obtained at said mobile device;
receiving, at said mobile device, one or more second messages from said server, said one or more second messages comprising an estimated location of said mobile device computed based, at least in part, on said measurements in said one or more first messages; and
requesting a version of a tile of positioning assistance parameters determined to be applicable for an area including said estimated location, wherein said version of said tile is based, at least in part, on a history of visits of said mobile device to said area, said tile being requested for use in obtaining one or more subsequent position fixes at said mobile device based, at least in part, on one or more subsequent measurements within said area.

2. The method of claim 1, wherein said history of visits comprises: a number of estimated locations of said mobile device clustered within said area; a number of said visits by said mobile device to said area; a number of tile requests for said area; time spent by said mobile device within said area; a type of a wireless network; a cellular carrier; a service contract; processing capability of said mobile device, or memory capacity of said mobile device; or any combination thereof.

3. The method of claim 1, wherein said tile of positioning assistance parameters is selectively requested in response to said estimated location of said mobile device being in a cluster of previous estimates of location of said mobile device.

4. The method of claim 3, wherein said cluster of previous estimates of location of said mobile device is determined based, at least in part, on determining whether a number of estimated locations of said mobile device are within a threshold distance.

5. The method of claim 4, wherein said number of estimated locations comprises: a number of consecutive estimated locations, or a number of absolute estimated locations; or any combination thereof.

6. The method of claim 3, wherein said cluster of previous estimates of location of said mobile device is further determined based, at least in part, on determining whether a number of “matched” estimated locations of said mobile device is within a threshold number.

7. The method of claim 1, wherein said version of said tile of positioning assistance parameters comprises: a multi-level tile; a higher-resolution tile, or a lower-resolution tile; or any combination thereof.

8. The method of claim 1, wherein said measurements obtained at said mobile device comprise: a media access control (MAC) address of a wireless transmitter; a cellular identification number (Cell ID) of a wireless transmitter; a transmission power level of a wireless transmitter; a received signal strength indication (RSSI) measurement of a wireless transmitter, or a round trip time (RTT) measurement of a wireless transmitter; or any combination thereof.

9. The method of claim 8, wherein said wireless transmitter comprises: a wireless area network (Wi-Fi) access point, or a cellular base station; a wireless transceiver; or any combination thereof.

10. The method of claim 1, wherein said measurements obtained at said mobile device are transmitted in the form of an Institute of Electrical and Electronics Engineers (IEEE) standard 802.11 (IEEE std. 802.111 scan list.

11. The method of claim 1, wherein said one or more subsequent position fixes are obtained without communicating with said server.

12. The method of claim 1, wherein said measurements obtained at said mobile device are stored in memory of: said mobile device, or a server; or any combination thereof.

13. An apparatus to perform a positioning operation comprising:
means for transmitting, via a mobile device, one or more first messages to a server, said one or more first messages comprising measurements obtained at said mobile device;
means for receiving one or more second messages from said server, said one or more second messages comprising an estimated location of said mobile device computed based, at least in part, on said measurements in said one or more first messages; and
means for requesting a version of a tile of positioning assistance parameters determined to be applicable for an area including said estimated location, wherein said version of said tile is based, at least in part, on a history of visits of said mobile device to said area, said tile being requested for use in obtaining one or more subsequent position fixes at said mobile device based, at least in part, on one or more subsequent measurements within said area.

14. The apparatus of claim 13, wherein said history of visits comprises: a number of estimated locations of said mobile device clustered within said area; a number of said visits by said mobile device to said area; a number of tile requests for said area; time spent by said mobile device within said area; a type of a wireless network; a cellular carrier; a service contract; processing capability of said mobile device, or memory capacity of said mobile device; or any combination thereof.

15. The apparatus of claim 13, wherein said means for selectively requesting said tile of positioning assistance parameters comprise means for selectively requesting said tile in response to said estimated location of said mobile device being in a cluster of previous estimates of location of said mobile device.

16. The apparatus of claim 15, wherein said cluster of previous estimates of location of said mobile device is determined via means for determining whether a number of estimated locations of said mobile device are within a threshold distance.

17. The apparatus of claim 16, wherein said number of estimated locations comprises: a number of consecutive estimated locations, or a number of absolute estimated locations; or any combination thereof.

18. The apparatus of claim 15, wherein said cluster of previous estimates of location of said mobile device is further determined via means for determining whether a number of “matched” estimated locations of said mobile device is within a threshold number.

19. The apparatus of claim 13, wherein said version of said tile of positioning assistance parameters comprises: a multi-level tile; a higher-resolution tile, or a lower-resolution tile; or any combination thereof.

20. The apparatus of claim 13, wherein said measurements obtained at said mobile device are transmitted in the form of an Institute of Electrical and Electronics Engineers (IEEE) standard 802.11 (IEEE std. 802.11) scan list.

21. The apparatus of claim 13, wherein said one or more subsequent position fixes are obtained without communicating with said server.

22. An apparatus to perform a positioning operation comprising:
a mobile device comprising:
a wireless transceiver to communicate with an electronic communications network; and
one or more processors coupled to a memory to:
initiate transmission of one or more first messages via said wireless transceiver to a server, said one or more first messages comprising measurements obtained at said mobile device;
receive one or more second messages at said wireless transceiver from said server, said one or more second messages comprising an estimated location of said mobile device computed based, at least in part, on said measurements in said one or more first messages; and
request a version of tile of positioning assistance parameters determined to be applicable for an area including said estimated location, wherein said version of said tile is based, at least in part, on a history of visits of said mobile device to said area, said tile being requested for use in obtaining one or more subsequent position fixes at said mobile device based, at least in part, on one or more subsequent measurements within said area.

23. The apparatus of claim 22, wherein said history of visits comprises: a number of estimated locations of said mobile device clustered within said area; a number of said visits by said mobile device to said area; a number of tile requests for said area; time spent by said mobile device within said area; a type of a wireless network; a cellular carrier; a service contract; processing capability of said mobile device, or memory capacity of said mobile device; or any combination thereof.

24. The apparatus of claim 22, wherein said one or more processors to said selectively request said tile of positioning assistance parameters further to selectively request said tile in response to said estimated location of said mobile device being in a cluster of previous estimates of location of said mobile device.

25. The apparatus of claim 24, wherein said one or more processors further to determine whether a number of estimated locations of said mobile device are within a threshold distance.

26. The apparatus of claim 24, wherein said one or more processors further to determine whether a number of “matched” estimated locations of said mobile device is within a threshold number.

27. A method for performing a positioning operation, comprising:
collecting measurements of wireless transmitters in an area to be stored as one or more clusters of position fixes with reference to said area;
obtaining a position fix based, at least in part, on said measurements of said wireless transmitters; and
in response to determining that said position fix being in a particular cluster of previous position fixes of said one or more clusters, accessing a version of a tile of positioning assistance parameters determined to be applicable for said area and said position fix for use in obtaining subsequent position fixes, wherein said version of said tile is based, at least in part, on subsequent measurements of at least one of said wireless transmitters in said area.

28. The method of claim 27, wherein said determining that said position fix being in said particular cluster further comprises determining whether a set number of position fixes are within a threshold distance.

29. The method of claim 27, wherein said determining that said position fix being in said particular cluster further comprises determining whether a set number of “matched” position fixes is within a threshold number.

30. The method of claim 27, wherein said positioning operation is performed via: a server; a mobile device, or any combination thereof.
